(19) United States
(12) Patent Application Publication
(10) Pub. No.: US 2011/0301753 A1
(43) Pub. Date: Dec. 8, 2011

(54) ROBOT CONTROLLER

(76) Inventor: Uwe Bonin, Friedberg (DE)

(21) Appl. No.: 13/154,732

(22) Filed: Jun. 7, 2011

(30) Foreign Application Priority Data
Jun. 7, 2010 (DE) 10 2010 022 931.8

(51) Int. Cl. B25J 9/18; B25J 19/06

(52) U.S. Cl. 700/245

(57) ABSTRACT

A controller for a robot has a receiver to receive safety information via a network data connection and safety arrangement that executes at least one safety function based on at least one received item of safety information. The safety arrangement includes a deactivation arrangement to deactivate at least one safety function.

### BACKGROUND OF THE INVENTION

1. Field of the Invention

The present invention concerns a method and a controller to control a robot, wherein the controller receives safety information about a network data connection.

2. Description of the Prior Art

In operation, robots can (for example) endanger a person who steps into the movement path of the robot and its environment, for example due to programming error, failure or malfunction of its controller, but also due to unpredictable environment conditions. Therefore safety functions are implemented in its controller that, for example, allow an automatic operation of the robot with high travel velocities only if safety gates are closed and no emergency off switches are activated.

In automatic systems, robots today are often activated via network data connections (for instance via PROFI BUS, PROFINET or Ethernet), for example by a central system SPC (stored program control). For safety reasons, for the most part the safety functions have not been implemented via these network data connections but rather separately via hard-wired relays, gates and the like. Secure network data connections—for example PROFISAFE—henceforth also enable the integration of safety functions.

However, the problem is thereby presented that safety information—for instance the state of safety gates, emergency off switches and the like—are not available in the robot controller as long as the network data connection is not established. In particular, a robot controller in which a safety means allows an actuation of the robot only if releases of safety gates, emergency off switches and the like are present cannot be placed in operation as long as the network data connection is not established, in particular if the robot is not connected with the network. For example, even if the system SPC and the robot controller are already connected with one another via a network data connection, provided safety gates, emergency off switches or the like are not integrated into the system SDS or the robot controller, and the system SPS cannot simulate the missing safety information of these safety devices without additional measures since then an endangerment (for example of the operator placing the robot into operation) on site cannot be precluded.

### SUMMARY OF THE INVENTION

An object of the present invention is to improve the operation—in particular the startup—of a robot.

According to one aspect of the present invention, a robot controller with a selective deactivation or muting function of at least some of its safety functions is provided. If the operator selectively deactivates safety functions chosen via the deactivation means of the robot controller, the robot controller can operate the robot even without a completely established network data connection, for example it can allow the robot to be moved manually and/or with reduced velocity in order to start it up.

In general, a controller according to the invention for one or more robots—in particular industrial robots of an automation system—has a receiver means to receive safety information via a network data connection. A network data connection can be at least one field bus, for instance PROFIBUS, PROFINET, EtherCAT, or EtherNet. It is advantageously a secure network data connection (in particular PROFISAFE, for instance according to IEC 61784-3-3) that is suitable for implementation of safety functions.

Furthermore, a controller according to the invention has a computerized safety module to execute one or more safety functions based on one or more items of received safety information.

Safety information in the sense of the present invention can depend on a state of a safety device (for example an emergency stop sensor or switch), a spatial monitoring and/or a robot state monitoring unit can describe or indicate this state. For example, the safety information can map the state of an emergency off switch (“activated” or “not activated” or “not activated but ready”) and/or the state of a work space or shelter monitoring (for example “breached” or “not breached” or “not breached but monitored”) that, for example, can be implemented via the monitoring of safety gates, light curtains and/or the (for example inductive or optical) monitoring spaces. For example, the safety information can additionally or alternatively map the state of a robot state monitoring, for instance whether a robot moves with reliable velocity and/or acceleration (in particular is at a standstill), whether forces and moments acting on the robot exceed limit values or the like.

Via the network data connection the receiver can receive safety information sent by the safety devices, for example. It can similarly also receive safety information from a device (in particular a system controller) that transfers these to the robot controller via the network data connection on the basis of signals from safety devices. For example, the safety module of the robot controller can allow a movement of the robot when release signals of provided safety devices (for instance emergency off switches, safety gate monitors or the like) are present, or no stop signals from these are present. After receiving corresponding signals, the system controller can similarly transfer a release signal or stop signal (which is received by the receiver and to which the safety module reacts) via the network data connection.

In general, in the sense of the present invention a safety function can permit or prevent a robot state or robot operation on the basis of at least one item of safety information. For example, a safety function can prevent a movement of the robot if no release signal of a spatial or robot state monitoring is present or if a stop signal of an emergency off sensor is present or allow a movement of the robot only if a release signal of a spatial or robot state monitoring is present or if no stop signal of an emergency off sensor is present.

According to the invention, a computerized deactivation module is provided to deactivate one or more safety functions that are executed by the safety module. A deactivation of a safety function in the sense of the present invention can allow or prevent a robot state or robot operation in spite of one or more items of safety information directing otherwise. For example, upon deactivation of the corresponding safety function a robot can travel even through no release signal from an emergency off sensor or a safety gate monitoring is present. In this way a robot can be actuated by the robot controller even if a network data connection has not yet been established, and thus start up of a robot of an automation system can occur.

In a preferred embodiment of the present invention, a safety function is deactivated by a computerized simulation module simulating one or more items of safety information received via the network data connection. In this way the remaining robot controller—in particular the safety module—can be operated without modification. The simulation module, for example, can overwrite corresponding data in the receiver or transfer data to the safety module instead of the receiver. Instead of the safety module, the deactivation module can similarly allow a release or cancel (or modify) a limitation activated by the safety module.

In order to ensure safety given deactivated safety function or deactivated safety functions, in a preferred embodiment one or more operating modes (which in this case are permitted or, respectively, are no longer permitted) are automatically selected by deactivating one or more safety functions. For example, upon deactivation of a safety function that prevents a robot movement given an opened safety gate, an automatic operation in which a robot moves with high velocity according to a predetermined program can be selected as no longer permitted. A manual operation in which a robot is directly controlled by the operator and/or a test operation in which an operator controls the execution of a predetermined program (for example step by step) can similarly be selected as permitted. In a preferred embodiment, an operation with reduced robot velocity and/or reduced or limited work space is selected as permitted of one or more safety functions are deactivated.

Various safety functions—for instance the dependency of a robot movement on the state of an emergency off sensor on the one hand and on the state of a safety gate on the other hand—can advantageously be selectively deactivated. Different operating modes can then also be permitted or not permitted depending on deactivated safety function. For example, given a deactivated safety gate safety function a continuous running of a predetermined program in a test operation can be permitted with reduced velocity; given a deactivated emergency off sensor safety function only a manual, step by step method can be permitted.

In a preferred embodiment the controller has an (in particular wearable) input means or, respectively, hand-held device to control the robot. For example, this can be connected with the robot controller directly or via the network data connection and advantageously has a safety device, in particular a consent sensor or, respectively, consent switch.

One or more safety functions cannot be deactivated by the deactivation module. in particular, a safety function can be provided that allows an actuation of the robot only given an activated consent sensor of a manual device cannot be deactivated. Furthermore, in this way the safety of an operator can be ensured even given deactivated, network-connected safety functions.

The controller itself and/or any module in the sense of the present invention, such as the receiver, safety module, deactivation module, simulation module, selection module or input means, can be realized in hardware and/or software as one or more components. For example, a robot controller can thus have one or more hardware components, in particular microcontrollers, calculation units (CPUs), memory and the like and/or one or more predetermined work programs for one or more robots. The deactivation module can be implemented, for example, as a software module and/or as a separate hardware component.

For example, deactivation module can be activated via an input at the robot controller.

A network data connection can be at least partially wired and/or at least partially wireless; in particular, data can be transferred by means of radio.

### BRIEF DESCRIPTION OF THE DRAWINGS

The FIGURE schematically illustrates a portion of an automation system with a robot controller according to one embodiment of the present invention.

### DESCRIPTION OF THE PREFERRED EMBODIMENTS

The FIGURE shows a stored program system control SPC to control an automation system with multiple industrial robots IR, of which only one is shown for clarity.

Its motors are connected with a movement controller MC of a robot controller RC that, for example, can be integrated into a control cabinet or on a PC (in particular industrial PC).

The robot controller RC has a bus interface IF to receive and transmit data via a PROFISAFE bus B via which the system control SPS also sends and receives data. For example, the SPS sends a start command to execute a work program (stored in the robot controller RC) to the robot controller RC via the bus B and receives responses from said robot controller RC via this bus B, for instance about the state (for example the pose) of the robot IR.

Safety devices—for instance cameras for optical monitoring of an allowable work space or, respectively, prohibited work space of the robot IR, light curtains or safety gate switches, as well as an emergency off switch NA (shown as an example)—are likewise integrated into the PROFISAFE bus B.

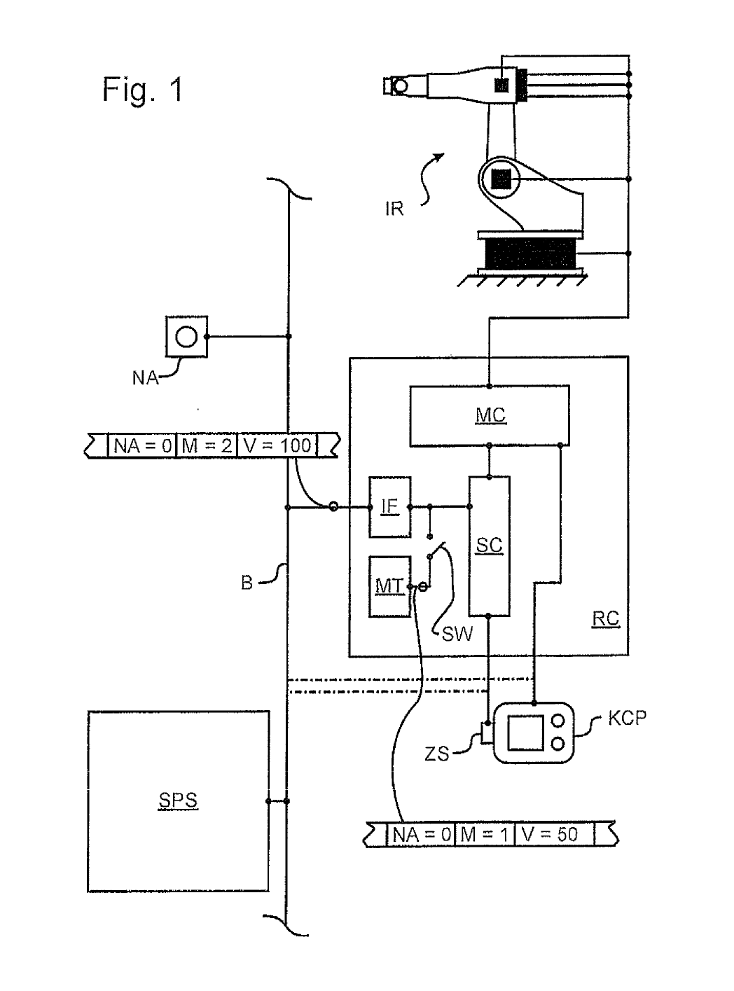

In normal or automatic operation, data (that are indicated per section in FIG. 1) are transferred via the bus B. The date “NA=0” indicates that the emergency off switch or all emergency off switches are connected and operationally ready but are not activated. “M=2” indicates that the automatic operation is permitted. “V=100” indicates that movement can be made with 100% of a predetermined velocity.

Among other things, the bus interface IF receives these data and thus forms a receiver in the sense of the present invention. A safety module SC (for example a corresponding program or a corresponding microcontroller) evaluates the data and allows a running of a predetermined work program with the full velocity predetermined for this by the movement controller MC only if (among other things) the safety information “NA=0 ” (no emergency off has been activated”) is received. It thus executes an emergency off switch safety function.

To control the robot IR, a hand-held device KCP is furthermore connected with its controller RC via which control commands—for example direct control commands for individual motors in a manual mode or a step by step adoption of stored poses in a test operation—can be transferred to the movement controller MC. A consent switch ZS of the hand-held device KCP is directly connected with the safety means SC that executes a consent switch safety function that allows a control of the robot via the hand-held device only given an activated consent switch ZS. As is indicated with a dash-dot line in FIG. 1, the hand-held device KCP and/or its consent switch can also be connected with the robot controller RC via the network data connection B.

If the network data connection B has not been completely established—for example because the robot controller RC, the emergency off switch NA or the system SPC are not integrated—the safety module SC normally prevents any actuation of the robot IR since provided, network-connected safety information (such as the state of the emergency off switch NA) is not present. A startup of the robot IR via manual control or, respectively, a test operation of predetermined programs would thus also not be possible although this would be possible without risk via manual control of the robot IR on site by the hand-held device KCP, even without taking into account the emergency off switch NA arranged far outside the work region of the robot.

Therefore, according to the invention a deactivation means is provided that has a simulation module MT and a selection module SW.

As the FIGURE indicates, the simulation module MT simulates the safety information “NA=0” (“no emergency off activated”) received via the network data connection B if it is activated via the selection module SW, in that it overwrites a corresponding data set in the receiver IF or instead transfers this to the safety module SC.

As indicated in the FIGURE, the simulated data set additionally comprises the information “M=1”, meaning that only manual and test operation (thus a control via the hand-held device KCP) are permitted but not an automatic operation activated by the SPS (“M=2”). Movement is thereby automatically made with only 50% of the predetermined velocity (“V=50”).

If the deactivation module is thus activated (i.e. if the switch SW is closed in FIG. 1), the safety means SC receives the simulated data “NA=0”, “M=1” and “V=50” independent of which information the receiver IF receives from the bus B. Its emergency off safety function is thus deactivated since it allows a movement of the robot IR even without release by the emergency off switch NA. The “Automatic operation” operating mode (“M=2”) is selected as presently not permitted or the manual operation and test operation (“M=1”) are selected as presently exclusively permitted, wherein movement can therein be made only with reduced robot velocity (“V=50”).

In contrast to this, the consent switch safety function cannot be deactivated by the deactivation module since, in the manual and test operation, the safety module SC furthermore requires the safety information from the consent switch ZS in order to move the robot IR. This is also possible in the variant indicated with a dash-dot line in that the simulation module MT does not simulate the corresponding datum (for instance “ZS=1”), such that the safety module SC receives this from the consent switch ZS without any changes via the bus B. An additional example of a safety function that cannot be deactivated upon startup even by the deactivation module is a robot state monitoring in which the safety module SC receives the poses, velocities and/or accelerations of the robot IR from the movement controller MC, compares these with limit values and triggers a stop (for example a STOP 0, STOP 1 or STOP 2) if the limit values are exceeded.

In contrast to this, given a deactivated safety function—i.e. if switch SW is closed (which switch SW can advantageously be implemented via an input into a program of the robot controller)—for example if the automatic operation is selected via the hand-held device KCP, this is blocked by the safety module SC since the deactivation module MT among other things simulates the instruction “M=1”, and thus the “Automatic operation” mode (“M=2”) has been selected as impermissible.

Although modifications and changes may be suggested by those skilled in the art, it is the intention of the inventor to embody within the patent warranted hereon all changes and modifications as reasonably and properly come within the scope of his contribution to the art.

I claim as my invention:

1. A computerized controller for a robot, comprising:
a computerized processor configured to generate control signals at an output of the computerized processor in a form adapted to operate a robot;
a network data connection;
a receiver that receives safety information via said network data connection and that provides said safety information to said computerized processor;
said processor comprising a safety module configured to executed at least one safety function dependent on said safety information received by the receiver; and
said processor comprising a deactivation module that is selectively operable to deactivate said at least one safety function.

2. A controller as claimed in claim 1 wherein said deactivation module comprises a simulation module configured to simulate at least one item of said safety information received via said network data connection.

3. A controller as claimed in claim 1 wherein said deactivation module comprises a selection module operable to select at least one operating mode by deactivating said at least one safety function.

4. A controller as claimed in claim 3 wherein said selection module is a component selected from the group consisting of an automatically operated selection module and a manually operated selection module.

5. A controller as claimed in claim 3 wherein said selection module is configured to implement a test operation by generating test commands that are supplied from said computerized processor to said robot.

6. A controller as claimed in claim 5 wherein said test operation is an operation selected from the group consisting of operation of said robot with a reduced velocity, an operation of said robot with a reduced workspace.

7. A controller as claimed in claim 1 comprising a safety device that assumes multiple states, and wherein said safety information is dependent on a state of said safety device.

8. A controller as claimed in claim 7 wherein said safety device is selected from the group consisting of an emergency step sensor, a spatial monitoring routine executed by said computerized processor and a robot state monitoring routine executed by said computerized processor.

9. A controller as claimed in claim 1 wherein said safety function is selected from the group consisting of a safety function that allows said robot to assume a robot state, a safety function that prevents the robot from assuming a robot state, a safety function that allows the robot to assume a robot operation, and a safety function that prevents the robot from assuming a robot operation.

10. A controller as claimed in claim 1 comprising an input unit in communication with said computerized processor and configured to supply input commands and data to said computerized processor that are used by said computerized processor to generate said control commands.

11. A controller as claimed in claim 10 wherein said input unit comprises a consent sensor.

12. A controller as claimed in claim 1 wherein said safety module is configured to implement at least one safety function that cannot be deactivated by said deactivation module.

13. An automation system comprising:
a robot; and
a computerized controller for said robot, comprising a computerized processor configured to generate control signals at an output of the computerized processor in a form adapted to operate a robot, a network data connection, a receiver that receives safety information via said network data connection and that provides said safety information to said computerized processor, said processor comprising a safety module configured to executed at least one safety function dependent on said safety information received by the receiver, and said processor comprising a deactivation module that is selectively operable to deactivate said at least one safety function.

14. A method for controlling a robot, comprising the steps of:
in a computerized processor, generating control signals at an output of the computerized processor, and operating a robot according to said control signals;
receiving safety information in electronic form via a network data connection accessible by said computerized processor;
with a safety module in said processor, executing at least one safety function dependent on said safety information received by the receiver; and
in said processor, operating a deactivation module to selectively deactivate said at least one safety function.

15. A non-transitory computer-readable storage medium encoded with programming instructions, said storage medium being loadable into a computerized controller that generates control commands to operate a robot, said programming instructions causing said computerized controller to:
generate control signals at an output of the computerized processor in a form adapted to operate a robot;
receive safety information via a network data connection;
in a safety module, execute at least one safety function dependent on said safety information received by the receiver; and
in a deactivation module, selectively deactivate said at least one safety function.
